(19) United States
(12) Patent Application Publication
(10) Pub. No.: US 2008/0257114 A1
(43) Pub. Date: Oct. 23, 2008

(54) BOLT AND SCREW HOLDING TOOL TO AIDE IN ASSEMBLY OR DISASSEMBLY PROCESS

(76) Inventor: Glen Earl Wyatt, Vallejo, CA (US)

Correspondence Address: GLEN E. WYATT SR., 533 TEMPLE WAY, VALLEJO, CA, 94591, US

(21) Appl. No.: 11/787,817

(22) Filed: Apr. 18, 2007

(51) Int. Cl. B25C 3/00

(52) U.S. Cl. 81/44

(57) ABSTRACT

An assembly of punched and formed material that has an ergonomically designed hood which covers a torsion spring that connects the hood to the formed and punched sliding hook. The hook and hood thereof is inserted and secured to the base which allows the hook to slide as the hood assembly is being pinched which opens the hook and allows the tool to be placed onto the threads of bolts, screws, or small pipe.

### FIELD OF INVENTION

This invention is related to and gives the assistance in work having the use of Bolts and Screws having to attach washers and nuts.

### BACK GROUND OF INVENTION

When assembling various types of equipment like, exercise and various gym machines, large and small lockers and cabinets, computer boards, decks, automobile repairs, garage doors and openers, plumbing, overhead industrial work which includes installing transformers and cross arms on telephone poles, installation of light fixtures, ceiling fans, street signs etc. Most of these jobs requires a person to have a third hand to hold a bolt or bolts in place for assembly purposes while the other puts on the washers and nuts. Some will attempt the work without asking for assistance only to get frustrated and sore from dropping the hardware and or from hyper-extending their arms to reach the washers and nuts to the bolts. When working overhead, often times some of the hardware falls to the ground and a person would have to go up and down their ladder to retrieve the hardware. Many times while one hand holds the bolt or screw in place, the other hand has to keep the piece being assemble together. While at the same time, holding the washers and nuts, a person then has to coordinate their fingers to grasp the washers and nuts to install them. This method of assembly can be very painful to the hands; especially when there are several washers and nuts (now referred to as hardware) to be installed.

Very often a second person is needed for the purpose of holding the bolt and items being assembled in place while the other person installs the hardware. The second person is sometimes hard to find and in industrial applications, can be costly. When I'm working at home and need a third hand having 3 sons, you'd think I could get one pretty easy . . . Not so!

Some people have attempted to use locking pliers which damages the threads. Others have used standard screwdrivers to hold a bolt in place while attaching the hardware; which too can damage threads.

Industrial tool companies have not supplied any tool that I know of that fulfills the need of this tool. I have searched many catalogs and internet tool suppliers only to come up empty handed.

Earlier versions of this tool that I developed were first a V-cut in some material that wedged the bolt or screw to the side of the material being assemble. The second modification was changing the v-cut to a hook which allowed me to put the hook onto the bolt which freed up both hands. The products being assembled were pretty heavy and the hook, on occasion, would allow the bolt to slip which made it more difficult to install the hardware. So, more modifications were needed.

After brainstorming and modifications, it developed into the present invention.

Field of Invention: This invention is related to and gives the assistance in work having the use of Bolts and Screws having to attach washers and nuts.

Back Ground of Invention: When assembling various types of equipment like, exercise and various gym machines, large and small lockers and cabinets, computer boards, decks, automobile repairs, garage doors and openers, plumbing, overhead industrial work which includes installing transformers and cross arms on telephone poles, installation of light fixtures, ceiling fans, street signs etc. Most of these jobs requires a person to have a third hand to hold a bolt or bolts in place for assembly purposes while the other hand puts on the washers and nuts. Some will attempt the work without asking for assistance only to get frustrated and sore from dropping the hardware and or from hyper-extending their arms to reach the washers and nuts to the bolts. When working overhead, often times some of the hardware falls to the ground and a person would have to go up and down their ladder to retrieve the hardware. Many times while one hand holds the bolt or screw in place, the other hand has to keep the piece being assemble together. While at the same time, holding the washers and nuts, a person then has to coordinate their fingers to grasp the washers and nuts to install them. This method of assembly can be very painful to the hands; especially when there are several washers and nuts (now referred to as hardware) to be installed.

Very often a second person is needed for the purpose of holding the bolt and items being assembled in place while the other person installs the hardware. The second person is sometimes hard to find and in industrial applications, can be costly. When I'm working at home and need a third hand having 3 sons, you'd think I could get one pretty easy . . . Not so!

Some people have attempted to use locking pliers which damages the threads. Others have used standard screwdrivers to hold a bolt in place while attaching the hardware; which too can damage threads.

Industrial tool companies have not supplied any tool that I know of that fulfills the need of this tool. I have searched many catalogs and internet tool suppliers only to come up empty handed.

Earlier versions of this tool that I developed were first a V-cut in some material that wedged the bolt or screw to the side of the material being assemble. The second modification was changing the v-cut to a hook which allowed me to put the hook onto the bolt which freed up both hands. The products being assembled were pretty heavy and the hook, on occasion, would allow the bolt to slip which made it more difficult to install the hardware. So, more modifications were needed.

After brainstorming and modifications, it developed into the present invention.

### SUMMARY OF INVENTION

The Bolt Backer invention is a bolt/screw holding tool. It has a soft hood to comfort the pinch grip pressure needed to open the hook which holds the bolt/screws. When the open hook is placed on a bolt/screw, it creates a three point contact onto the threads of the bolt/screw when the hood pressure is released. The bolt is now locked. Under the hood is a torsion spring that closes the hook sliding system into the v-cut at the tip of the base which locks the bolt or screw and holds it in place. The v-cut at the tip of the base has a beveled edge. With the thin hook material, they fit between the treads of most size bolts and screws, limiting the slipping thereof. The extension between the v-cut and the first guide provides a very thin space to slip between tight tolerances of hardware and material. This thin space is crucial when working with carriage bolts, getting them to set in position. The round cut in the first guide at the tip of the base is to allow space for the washers; so they will not interfere with the working distance on the bolt. The space between the first guide and the second guide is the flex shaft. The flex shaft allows the tool to bend when working in tight or odd angles. In it's resting position, the sliding hook is set at the back edge of the v-cut; not showing any open area. This allows the tool to be used on very small screws and bolts.

### BRIEF DESCRIPTION OF DRAWINGS

FIG. 1 Is a complete assembled drawing of the tool invention.

FIG. 2 Is a layout of punches made in the sliding hook material.

FIG. 3 Is the bends, folding, and layout of punches in the sliding hook material.

FIG. 4 Is the ergonomically designed hood detail.

FIG. 5 Is the developmental drawing of the torsion spring.

FIG. 6 Is the developmental drawing of the base.

### DRAWINGS IN DETAIL

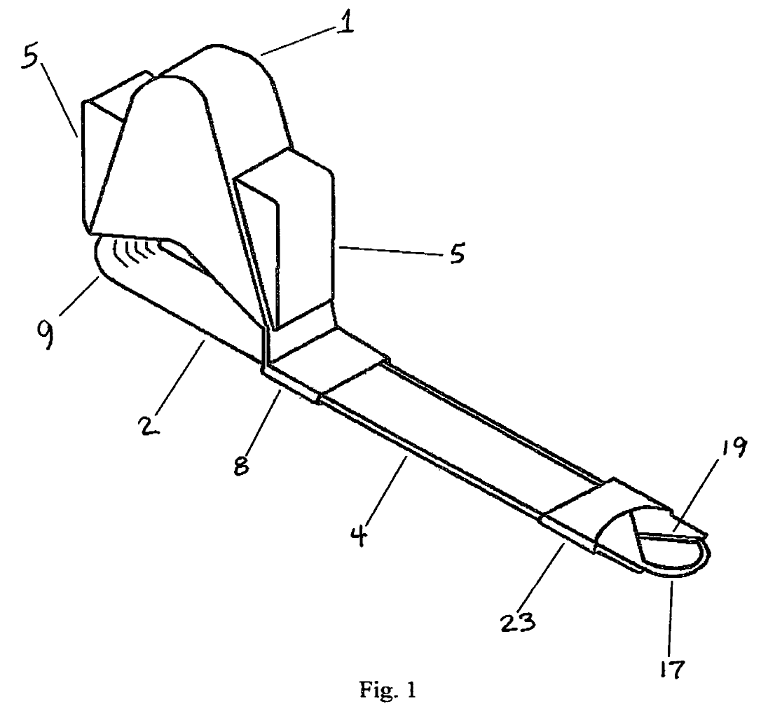

FIG. 1 shows the complete drawing of the invention in it's fully assembled state. 1 the ergonomic hood has ergo pads 5 to alleviate soft tissue compression. The hood 1 is formed of, non limiting example and can be any other material, soft rubber material which has three purposes; A) To form a safety barrier between the assembled parts and a person's hand B) It has internal assembly points to the unit and C) Forms a protective sleeve over the second guide anchor 26 which may have a sharp edge.

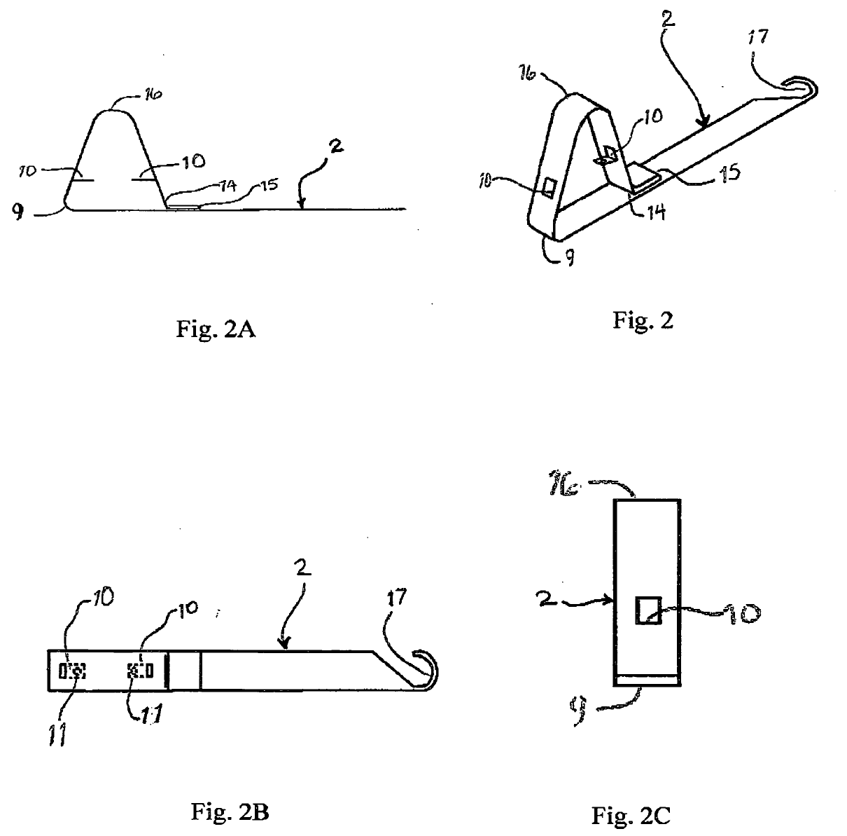

FIG. 2 is the sliding hook 2 layouts and punch details none limiting to example made of spring steel. The hook 17 is an oval punch which is angled on the end of the sliding material 2. 9 is the first bend; it's over 90 degrees, bending back towards the hook 17. 10 is a three sided punch cut that point away from the hook 17. 11 is the anchor hole for the spring 3 stab 18. 18 is inserted into 11 and 6 locking them in place. 16 is the place where an approximate 315 degree bend is located. 12 is the second three sided punch with a hole 13, and top side of the punch is facing or pointing toward the hook 17. 15 is a 180 degree bend that happens last. It bends around the base 4, around the guide 26.

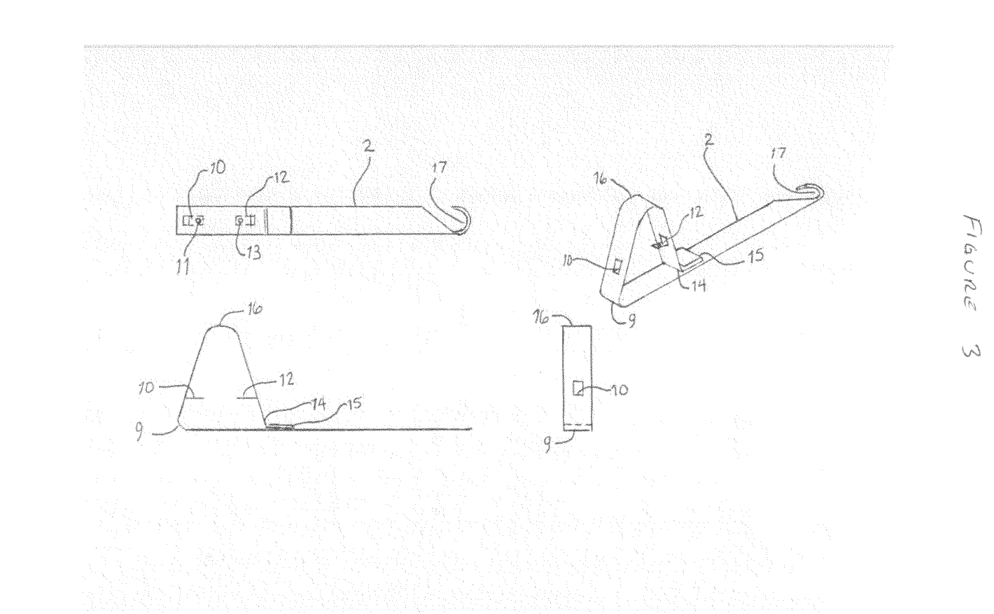

FIG. 3 Shows the detail of the bends 9, 16, 14, and 15 in relation to the hook 17. It also shows the layout of 10 and 12 also bends.

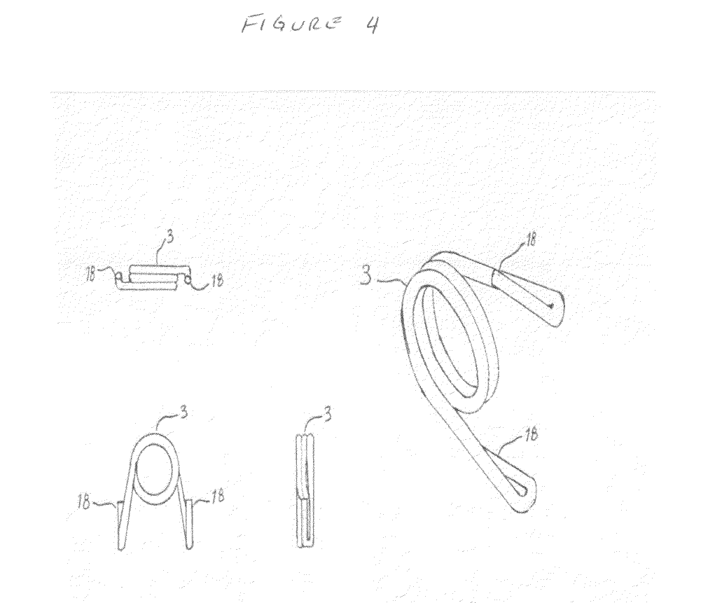

FIG. 4 is the diagram of the hood 1 which covers 15 and 26. After 2 the slide is installed into 4 the base, 8 slides down 2 and 4 respectively until it covers 26 and 15. 1 is then pulled over 16. 7 is installed into 11 and 13 and two 6's. The hood assembly is now in place.

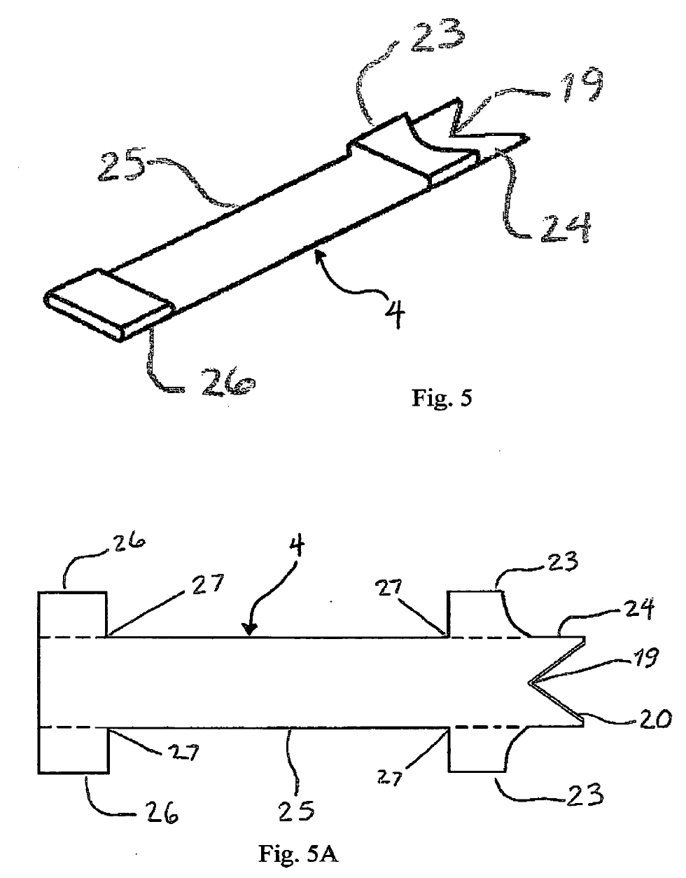

FIG. 5 is the torsion spring 3 which installs under the hood 1 when it is placed over 2 and 4.

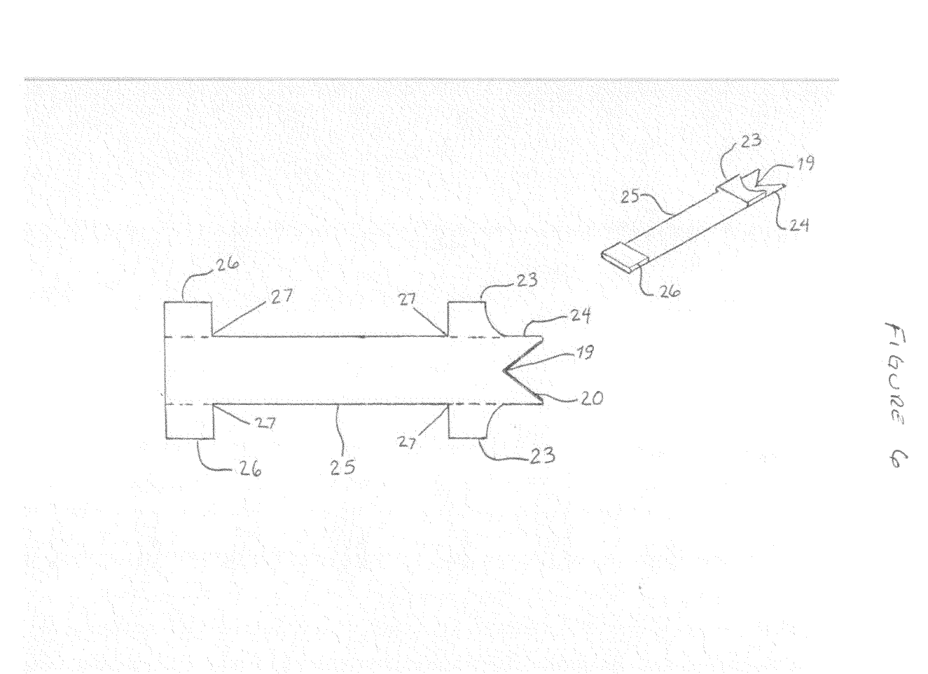

FIG. 6 is the base 4. The base can be fabricated of, non limiting example, nylon or some other tough flexible plastics. Spring steel is good to use also, along with 2 the hook slide. 27 are the fold lines and 26 are the tabs that are being folded. 25 is the flex shaft that bends and allows the hook to be used in odd angles. 23 is the tabs that makes guide 2. This guide 2 has a round inset that allows the tool to fit in tight spaces. 24 is a flat thin surface that allows the hardware to snug up so square shanks on carriage bolts will lock into place. 19 is the edge of the base. When the slide 2 hook 17 is closed onto a screw or bolt, 17 and 19 creates a three point contact with the bolt. 20 is an edge which when 17 and 19 comes together on a bolt or screw, 20 slides into the threads thus locking the bolt or screw in place. With the pressure being applied to the bolt by 3 it will hold most bolts and material being assembled in place without slipping.

References cited: U.S. Pat. Nos. 3,960,356 6,832,869 2,972,697 4,056,301 4,500,240 5,302,070 4,641,478 D,337,518

Current Class Searched: 411/84,85,107,352,353,433,437,526,970,999 D8/349,354,373 D25/133 52/704,705 249/205

Having this described the invention, I claim:

1. An assembled apparatus which when attached to a threaded piece of material, be it screw, bolt, tubing, or pipe, holds such in place to allow a person to have a hand freed from holding said material in an assembly process, comprising of:
An ergonomic hood that has pads for soft tissue compression, with holes in gussets for assembly, and a sleeve which slides onto and over the hook slide and anchor body bridge.
A punched and bended hook slide material which attaches to said ergonomic hood, and said anchor body.
A anchor body which has a V cut notched into the frontal part, two bridge supports; one in front that has a curved notch facing the V cut and the rear having a solid bridge of which holds the said hook slide device.
A torsion spring that holds the said ergonomic hood to the said hook slide device.

2. Apparatus as set forth in claim 1, wherein said ergonomic hood is molded with sides, top, pads with gussets, and a sleeve which covers said hook slide and said anchor body rear bridge.

3. Apparatus as set forth in claim 1, including said hook slide device bends and has punched gussets with holes for assembly to said ergonomic hood, with punch on end of material for hook latch.

4. Apparatus as set forth in claim 1, including said anchor body has V cut in the frontal part with an edge to allow said V cut to fit between threads of screws, bolts, and pipes.

5. Apparatus as set forth in claim 1, including said torsion has straight ends that slides into said holes in gussets of ergonomic hood, which sleeve is slid over the hook slide device that is attached to the anchor body bridge which makes assembly.

6. Apparatus as set forth in claim 5, wherein the assembled apparatus, when squeezed, opens the hook slide latch allowing apparatus to fit over said screws, bolts, and pipes that are threaded.

7. Apparatus as set forth in claim 4, wherein when said apparatus is squeezed and put onto threads of a screw, bolt, or pipe, said apparatus edged V cut and hook latch locks on to threads by pressure applied by said torsion spring, thus securing threaded material.
